(19) United States
(12) Patent Application Publication
(10) Pub. No.: US 2011/0229869 A1
(43) Pub. Date: Sep. 22, 2011

(54) DISPLAY METHOD FOR MAXIMAL USE OF SHORTCUT NUMBERS FOR CELLULAR PHONE

(76) Inventor: Yong-Sik Lee, Kyungki-do (KR)

(21) Appl. No.: 13/132,812

(22) PCT Filed: Dec. 9, 2009
(86) PCT No.: PCT/KR2009/007259

§ 371 Date: Jun. 3, 2011

(30) Foreign Application Priority Data
Dec. 9, 2008 (KR) 10-2008-0124419

(51) Int. Cl. G09B 25/00

(52) U.S. Cl. 434/365

(57) ABSTRACT

Display methods adding the speed dial number(s) of the called or calling party on the current display of the user's phone so that he/she could memorize and use many speed dial numbers in a shorter period of time. If any cellular subscriber who is using only a few speed dial numbers due to poor memory begins to experience the display method of this invention, he/she can memorize most of necessary speed dial numbers in his/her daily life by dint of the associations being reacted by conditioned reflex, and use them for the rest of his/her life. When a phone user receives a call; Method of displaying the speed dial number(s) and contact name (ID) of a calling party on the receiver's phone; Method of flashing the above two letters alternately to enhance the effect of being associated with each other. When a phone user makes an outgoing call; Method of displaying the speed dial number(s) and contact name (ID) of the called party on the caller's phone. If a caller makes a call by using the search functions or entering the phone numbers; Method of flashing only the speed dial number(s) to enhance the efficiency of recognizing it for the caller: If the caller makes a call by entering a speed dial number(s); Method of flashing only the contact name (ID) of the called party to enable the caller to confirm the called party who is associated with the speed dial number(s) just pressed. The caller places a call and habitually recognizes the speed dial number which is associated with the called party on the line. Every cellular subscriber who is using the cellular phone upgraded with this invention will enjoy the effect that he/she can naturally memorize the speed dial numbers not only necessary for every day's frequent calls but also important for the persons in contact with him/her by phone calls for long.

### BACKGROUND OF THE INVENTION

This invention is regarding the audiovisual display methods that enable cellular subscribers to easily memorize shortcut or speed dial numbers, being useful only when in memory, which are displayed momentarily on the phone while the bell is ringing before starting to talk.

Cellular subscribers get to memorize a necessary speed dial number(s) naturally by virtue of mutual associations between a contact name and its speed dial number(s), which are automatically made by concentration and accumulation of the same audiovisual recognition for long.

Also, it is a method technique which constantly reminds a cellular subscriber of the shortcut numbers to be memorized so that he/she can make use of them any time, if necessary.

If the speed dial number(s) of a calling party is additionally displayed by the cellular service provider on the first line of the current CID (caller identification service) display, whenever a cellular phone user receives a call from the same person, the CID display will make him/her repeat an identical recognition of the same speed dial number(s), and easily memorize and use it. The display method by cellular providers' service was applied for a patent and published under Application No. KR 10-2006-0018960

A condition for using any speed dial number(s) with ease is that the speed dial information should be kept alive in memory. And the condition can be partially met by a simple method just additionally displaying the speed dial number(s) of a calling party on the CID display whenever a cellular phone user receives a call, and it has been already cited as the background art (10-2006-0018960). The background, art has a merit producing the effect that many speed dial numbers could be memorized without making any special efforts using the speed dial number(s). However, if a phone user keeps depending on only a passive method of recognizing the speed dial numbers of his/her receiving calls, the method is little effective in making him/her automatically memorize the speed dial numbers assigned to some persons who call him/her infrequently.

That is the problem to be solved by this patent application.

And the method in the above-cited patent application (10-2006-0018960) displays the speed dial number(s) and name (ID) of a calling party so plainly without any characteristic mark on the phone display of a called party. Therefore, it is also necessary to improve the plain display method in order to catch a phone user's eyes while the speed dial number(s) is displayed, which is the core information to be memorized by virtue of his/her good associations.

### SUMMARY OF THE INVENTION

To overcome the conventional disadvantages, it is desirable that a phone user has an audiovisual recognition of any speed dial number(s) together with its contact name as often as possible in order to have associations between the two be initiated and turned into a stage of short term memory that will be followed by that of long term memory. However, the method in the above-cited patent application (10-2006-0018960) can have a phone user recognize a speed dial number(s) only when he/she receives a phone call.

But, this invention is to display a speed dial number(s) in case of not only receiving a call but also placing a call. So, if a phone user exchanges phone calls with any same person stored in the phone's memory, his/her opportunity and frequency of recognizing the same speed dial information would be naturally increased. Besides, when a phone user receives a call, this invention is to flash the contact name and speed dial number(s) of the calling party alternately with a frequency of approximately 1 to 2 times per second so as to have him/her make good associations between the two.

As the vocal information is easier to remember when it is repeatedly heard, the display method in repeating motion is more effective way which is flashing a speed dial number(s) and its contact name alternately for making good associations between the two.

The display method of this invention is to flash only the speed dial number(s) whenever a phone user places an outgoing call by using any other way but speed dialing. And if any wrong speed dial number(s) is pressed, the invention is to flash only its contact name so that the phone user can realize the wrong connection at once.

As the wrong answers by mistakes in our school days would stay longer in our memory, the associations made by dint of positive experiences of making a few mistakes related to any speed dial number(s) would be more effective in memorizing and keeping it as a long term memory.

If any phone user memorized most of the speed dial numbers by virtue of this invention in shorter period of time, needless to say, he/she would never use a lot the search functions of the phone as before. Consequently, it will save that much of the battery power.

### BRIEF DESCRIPTION OF THE DRAWINGS

FIGS. 1-3 are for the case of placing an outgoing call to a person stored in the phone's memory, and FIGS. 4-5 are for the case of receiving a call from the person, wherein:

FIG. 1 is a view showing a display method when a cellular subscriber enters a speed dial number(s) for making a call;

FIG. 2 is a view showing a display method when a cellular subscriber enters anything but speed dial number(s) for making a call;

FIG. 3 is a view showing a display method when a cellular subscriber makes a call to a person stored without a speed dial number(s) in the phone's memory;

FIG. 4 is a view showing a display method when a cellular subscriber receives a call from a person stored in the phone's memory;

FIG. 5 is a view showing a display method when a cellular subscriber receives a call from a person stored without a speed dial number(s) in the phone's memory;

FIG. 6 is a view showing that when a speed dial number(s) is available, layouts of speed dial information on the display, for an example; and

FIG. 7 is a view showing that when a speed dial number(s) is not available, layouts of speed dial information on the display, for an example.

### DETAILED DESCRIPTION OF THE INVENTION

It is desirable that a phone user has an audiovisual recognition of any speed dial number(s) together with its contact name as often as possible in order to have associations between the two be initiated and turned into a stage of short term memory that will be followed by that of long term memory.

This invention is to display a speed dial number(s) in case of not only receiving a call but also placing a call. So, if a phone user exchanges phone calls with any same person stored in the phone's memory, his/her opportunity and frequency of recognizing the same speed dial information would be naturally increased. Besides, when a phone user receives a call, this invention is to flash the contact name and speed dial number(s) of the calling party alternately with a frequency of approximately 1 to 2 times per second so as to have him/her make good associations between the two.

As the vocal information is easier to remember when it is repeatedly heard, the display method in repeating motion is more effective way which is flashing a speed dial number(s) and its contact name alternately for making good associations between the two.

The display method of this invention is to flash only the speed dial number(s) whenever a phone user places an outgoing call by using any other way but speed dialing. And if any wrong speed dial number(s) is pressed, the invention is to flash only its contact name so that the phone user can realize the wrong connection at once.

As the wrong answers, by mistakes in our school days would stay longer in our memory, the associations made by dint of positive experiences of making a few mistakes related to any speed dial number(s) would be more effective in memorizing and keeping it as a long term memory.

If any phone user memorized most of the speed dial numbers by virtue of this invention in a shorter period of time, needless to say, he/she would never use a lot the search functions of the phone as before. Consequently, it will save that much of the battery power.

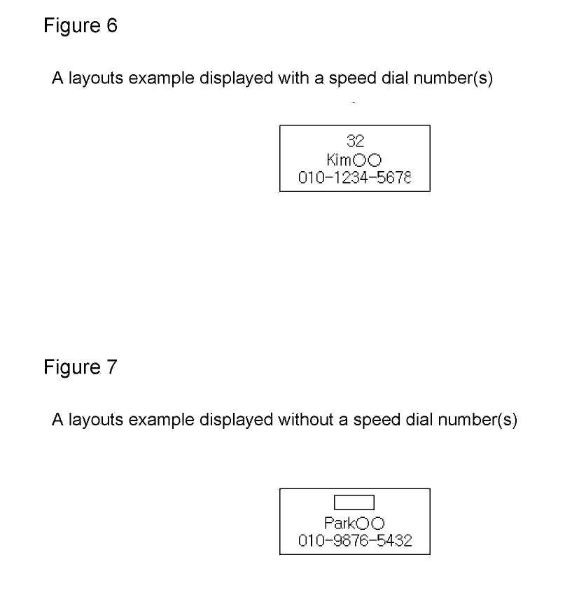

First, for cellular subscribers' a lot of experiences of recognition that is necessary to easily memorize the persons' speed dial information stored in the phone's memory, whenever they place an outgoing call as well as receive an incoming call, this invention is to display a speed dial number(s) as the 1st information, its contact name as the 2nd one, and its entire phone numbers as the 3rd one on the phone's display, as shown in FIGS. 6 and 7.

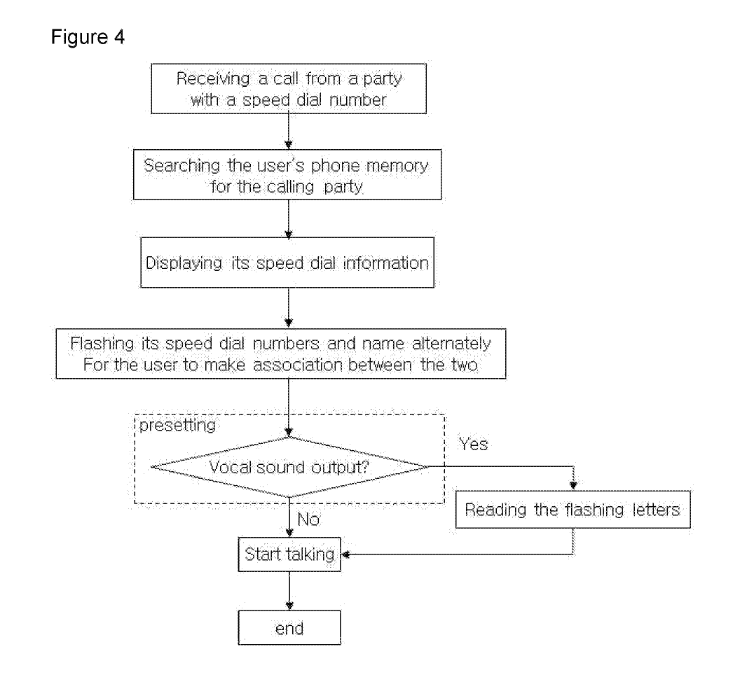

Second, differently from the conventional monotonous display method, this invention is to flash the speed dial number(s) and contact name of a calling party alternately with a frequency of approximately 1 to 2 times per second to enhance the phone user's visual, recognition effect, as shown in FIG. 4.

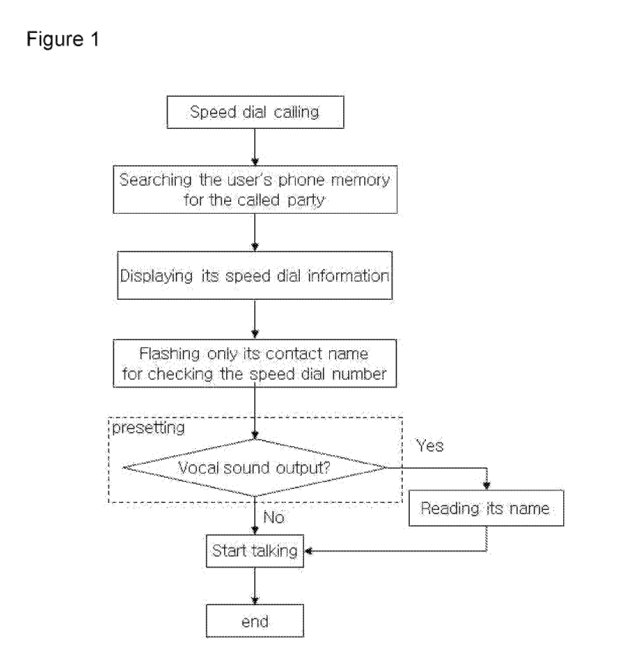

Third, when an outgoing call is placed to somebody stored in the phone's memory by speed dialing, this invention is to flash only the contact name of the called party repeatedly with a frequency of approximately 1 to 2 times per second for the caller to confirm the called party associated with the speed dial number(s), as shown in FIG. 1.

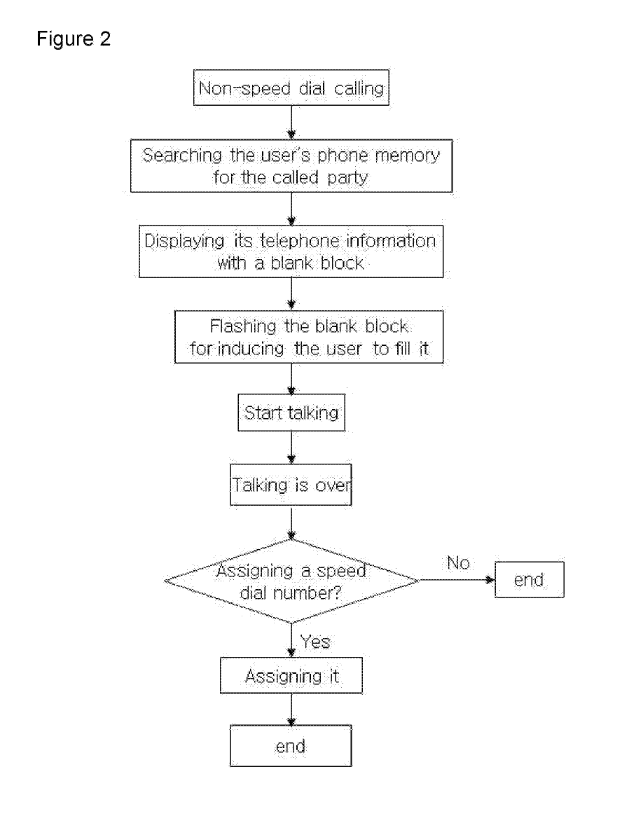

Fourth, if the caller places an outgoing call by using any other way but speed dialing, this invention is to flash only the speed dial number(s) of the called party repeatedly with a frequency of approximately 1 to 2 times per second to make the caller clearly recognize the number(s), as shown in FIG. 2.

Fifth, in addition to the visual methods flashing the above-mentioned letters 1˜2 times per second, this invention also has a vocal sound function, to be preset for activation, in behalf of the phone users who are weak-sighted or blind, and who want it, which is to read the flashing letters loudly but simultaneously with its every flashing, as shown in FIGS. 1, 2 and 4.

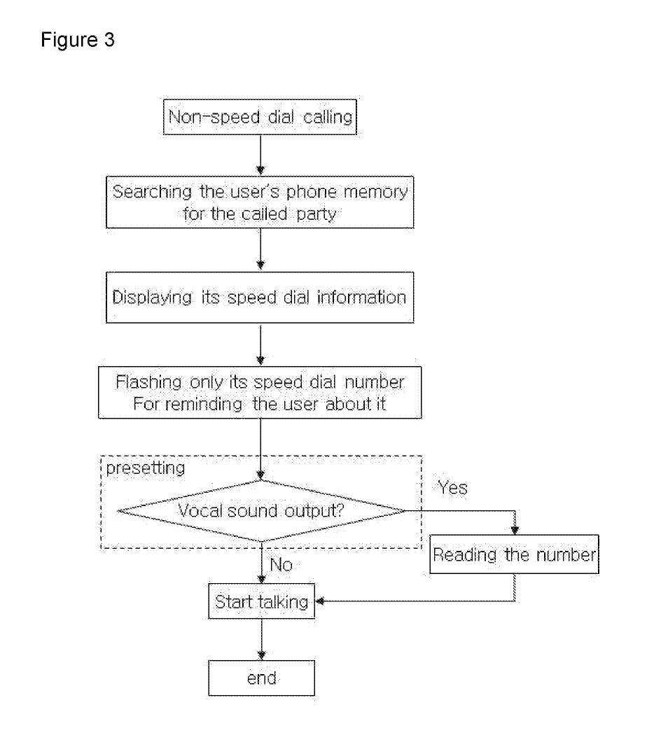

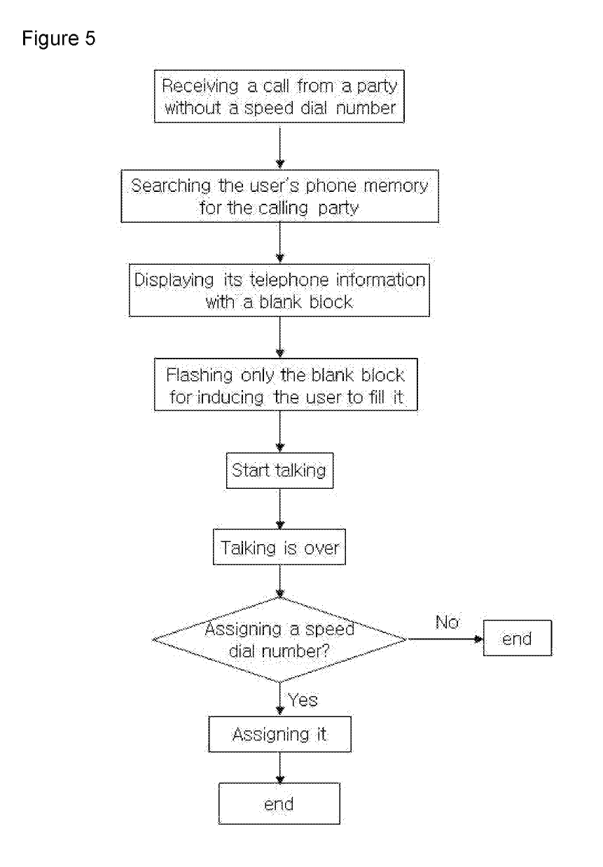

Sixth, if a call is connected with somebody who has been stored without a speed dial number(s) in the phone's memory, the functional displays of this invention is to flash the blank box in which the speed dial number(s) is supposed to be filled, as shown in FIGS. 3 and 5.

As for the display methods for a called party, this invention is to flash the speed dial number(s) and contact name of a calling party alternately on the display lighted with a bell sound in order to help the cellular subscriber have much experience of recognizing the speed dial information for making good associations between the number and name in a shorter period of time, as shown in FIG. 4.

When a cellular subscriber receives a call from somebody stored without a speed dial number(s) in the phone's memory, this invention is to flash only the blank box in which the speed dial number(s) is supposed to be displayed so as to induce the phone user to fill it, as shown in FIG. 5.

If the vocal sound function is preset for activation, the function is to read the flashing letters loudly, but simultaneously with its every flashing, as shown in FIGS. 1, 2 and 4.

As for display methods for a calling party, in order to make a cellular subscriber use a speed dial number(s) with confidence, this invention is also to display a speed dial number(s) and its contact name (ID) of the called party on the caller's phone display, as shown in FIG. 6.

When a cellular subscriber places a call by pressing a speed dial number(s), this invention is to flash only the contact name of the called party in order to enable him/her to make sure at once if the speed dial number(s) has been correctly pressed, as shown in FIG. 1.

But when a cellular phone user enters anything but a speed dial number(s), this invention is to flash only the speed dial number(s) of the called party which is to be effectively recognized and memorized, as shown in FIG. 2.

When a cellular subscriber makes a call to somebody stored without a speed dial number(s), this invention is to flash only the blank box in which a speed dial number(s) is supposed to be displayed so as to induce him/her to fill it, as shown in FIG. 3.

And if the vocal sounds function is preset, the function will read only the flashing letters loudly, but simultaneously with its every flashing, as shown in FIGS. 1 and 2.

If a cellular subscriber got accustomed to some degree to the phone upgraded with the display method program of this invention, he/she could make most of daily calls by using many speed dial numbers in memory. And if the numbers of speed dial calling began to increase gradually, the subscriber would suddenly feel uneasy and annoyed some day when he/she ought to use the search functions which had been thought to be very convenient for long before then.

Man has a natural instinction to prefer something easier.

So, when it comes to placing a call, the cellular phone upgraded with this invention can be regarded as the best one, because of the universality enabling all the cellular subscribers to memorize and use speed dial numbers which is the handiest means for placing a call.

In that, the display method of this invention could be a basic function for all kinds of cellular phone someday in the future.

What is claimed is:

1. A display method for enabling a cellular subscriber to naturally memorize and use many speed dial numbers in the phone's memory by dint of habitual recognition consisting of: displaying the speed dial number(s) of a called party when to place a call or that of a calling party when to receive a call, as 1^{st} information, its contact name as 2^{nd} one, and its entire phone numbers as 3^{rd} one on the phone's display.

2. When to receive a call from a person stored in phone's memory; Display methods consisting of: flashing the speed dial number(s) and its contact name of a calling party alternately with a frequency of 1 to 2 times per second for providing a cellular subscriber with a condition to make associations producing a conditioned reflex, and flashing only the blank box indicating the position of the speed dial number(s) of a calling party so as to induce him/her to fill it,
Wherein when to place a call to a person stored in the phone's memory; Display methods consisting of: flashing only the contact name of the called party with a frequency of 1 to 2 times per second for the cellular subscriber to make sure if the speed dial number(s) is correctly pressed, flashing only the speed dial number(s) for reminding the subscriber of the number(s) in case of entering the result from the search functions or any phone numbers instead of a speed dial number(s), and flashing only the blank box indicating the position of the speed dial number(s) of a called party so as to induce him/her to fill it.

3. A display method in behalf of the blind and weak-sighted who need a vocal sound information, or for the ordinary persons who want it including: a vocal method, being preset for functioning, to read the flashing letters aloud, but simultaneously with its every flashing.
